(19) United States
(12) Patent Application Publication
(10) Pub. No.: US 2007/0278987 A1
(43) Pub. Date: Dec. 6, 2007

(54) Electrical Multiphase machine and method for operating same

(75) Inventors: Martin Bartholet, Rapperswil (CH); Pascal Bosch, Zurich (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Levitronix LLC, Waltham, MA (US)

(21) Appl. No.: 11/786,024

(22) Filed: Apr. 9, 2007

(30) Foreign Application Priority Data
May 31, 2006 (EP) 06405241.8

(51) Int. Cl. H02P 27/04

(52) U.S. Cl. 318/800

(57) ABSTRACT

An electrical multiphase machine is proposed with a stator (3) including a winding (5;6) having at least two strands (51, 52, 53; 61, 62) for generating an electromagnetic field, each strand (51, 52, 53; 61, 62) belonging to a different electrical phase; furthermore with a setting device (4) which supplies each strand (51, 52, 53; 61, 62) with a phase current (Ia, Ib, Ic) or phase voltage (Ua, Ub, Uc) in each case as a setting parameter, said setting device (4) including) a separate power amplifier (41a, 41b, 41c, 41d) for each strand (51, 52, 53; 61, 62), so that the setting parameter can be regulated for each strand (51, 52, 53; 61, 62) independently of the setting parameters for the other strands (51, 52, 53; 61, 62) and at least one common connection point (VP) being provided to which at least two of said strands (51, 52, 53; 61, 62) are connected, and wherein an additional active control element (44) is provided for shifting the potential of said connection point (VP). Furthermore a method of operating such a machine is proposed.

This application claims the priority of European patent application No. 06405241.8, dated May 31, 2006, the disclosure of which is incorporated herein by reference.

The invention relates to an electrical multiphase machine as well as to a method for operating the same in accordance with the preamble of the independent claim of the respective category.

Electrical multiphase machines such as, for example, electrical rotary field machines, electrical rotary drives, electromagnetic bearings or bearingless motors usually have setting devices with which the strands belonging to the various phases are each supplied with a phase current or with a phase voltage as the setting parameter. These setting devices include power amplifiers for the individual strands, the power amplifiers often being configured as switching amplifiers with power switches and freewheeling diodes and being operated on the principle of pulse width modulation.

A permanent magnet energized electrical rotary drive is known, for example, from EP-A-0 989 656 in which the setting device for each strand includes a bipolar power amplifier configured as an H-bridge circuit. This results in four power switches and four freewheeling diodes being needed for each strand which represents a not insignificant effort with respect to apparatus, space requirements and costs.

As an alternative, it is proposed in EP-A-0 989 656 to provide a bridge branch as the power amplifier in each case. Such a circuit, also termed a half bridge circuit, is substantially half an H-bridge. Each strand is then connected, on the one hand, to the bridge branch supplying it and, on the other hand, to a star point common to all strands. The star point is maintained at a fixed potential located in the middle between the two operating potentials of the power amplifiers. These operating potentials are DC potentials. For example the negative operating potential can be the ground potential and the positive operating potential a higher potential, as compared thereto, or the two operating potentials are selected to be symmetrical relative to the ground potential. The half bridge circuit, allows the apparatus effort, and thus also the cost aspect, to be reduced because only two power switches and two freewheeling diodes are needed per strand, but the dynamic response is reduced because only half the potential difference of the two operating potentials is available as the maximum voltage by amount for each strand.

Starting from this prior art, it is an object of the invention to propose an electrical multiphase machine having a different setting device which requires as little effort as possible apparatus-wise and simultaneously permits the largest possible dynamic response. It is furthermore an object of the invention to provide a corresponding method for operating such an electrical multiphase machine.

The subject matters of the invention satisfying these objects in an apparatus and in a method respect are characterized by the features of the independent claims of the respective category.

In accordance with the invention, an electrical multiphase machine is therefore proposed with a stator which includes a winding having at least two strands for generating an electromagnetic field, each strand belonging to a different electrical phase; furthermore with a setting device which supplies each strand with a phase current or phase voltage in each case as a setting parameter, the setting device including a separate power amplifier for each strand so that the setting parameter can be regulated for each strand independently of the setting parameters for the other strands, with at least one common connection point being provided to which at least two of the strands are connected, and with an additional active control element being provided for shifting the potential of the connection point.

Due to the common connection point for the at least two strands, the power amplifiers for these two strands can be designed more simply apparatus-wise, for example as bridge branches. Since, in addition to this, the potential of the connection point can be shifted by the active control element, a significantly greater dynamic response results than in known power amplifiers with bridge branches and a star-point circuit, since when, for example, as large a positive voltage as possible is required for a strand, the potential of the common connection point can now be reduced at least approximately down to the negative operating potential so that the total difference between the two operating potentials is available as a voltage for this strand. The multiphase machine in accordance with the invention thus permits an advantageous combination of low apparatus effort and a dynamic response which is as large as possible.

In accordance with a particularly preferred embodiment, the multiphase machine is configured as a bearingless motor with a magnetically journalled rotor, the stator including two windings, namely a drive winding having at least two strands for generating a magnetic drive field effecting a torque on the rotor, and a control winding having at least two strands for generating a magnetic control field with which the position of the rotor can be regulated relative to the stator, each strand of the drive winding belonging to a different electrical drive phase and each strand of the control winding belonging to another electrical control phase, the setting device for each strand of the drive winding and for each strand of the control winding includes a separate power amplifier, so that the setting parameter for each strand and can be regulated independently of the setting parameters for the other strands.

Each power amplifier and each active control element is preferably configured in each case as a bridge branch of the setting device. Conventional components known per se such as, for example, multiphase current setters, can namely be used due to this measure.

In a preferred embodiment, all strands are connected to the same connection point. This measure permits a particularly favorable embodiment apparatus-wise and with respect to space requirements and costs. Thus, namely, only n+1 bridge branches are needed for an n-phase machine, for example, namely n bridge branches for the n strands and a bridge branch as an active control element for shifting and controlling the potential of the monitoring point.

As an alternative it is, however, also possible, to provide a plurality of different connection points, wherein for each connection point an additional active control element is provided for shifting the potential of the respective connection point. The current flowing through the connection point can be reduced by this measure.

A further advantageous aspect involves the setting device including at least one three-phase current or voltage setting device with three bridge branches, two of the bridge branches being the power amplifiers for two strands and the third bridge branch being the active control element since conventional three-phase setting devices can the used for the realization.

For the bearingless motor, it is a particularly preferred measure that at least one connection point, preferably each connection point, is connected to precisely one strand of the drive winding and to precisely one strand of the control winding. Since, in normal operation of the bearingless motor, the current required by the control winding regulating the bearing of the rotor is significantly lower than the current required for driving the motor, the resulting voltage for the drive strand can be increased by a corresponding shifting of the potential of the connection point so as to have higher current available for the drive strand without thereby endangering proper journalling of the rotor. When one strand of the control winding and one strand of the drive winding are each connected to a common connection point, the current flowing through the connection point is in addition much lower than in comparison with a circuit in which two strands of the drive winding are applied to a common connection point.

A method is furthermore proposed by the invention for operating an electrical multiphase machine with a stator including a winding having at least two strands for generating an electromagnetic field, each strand belonging to a different electrical phase; furthermore with a setting device including a separate power amplifier for each strand, and with at least one common connection point being provided to which at least two of the strands are connected. In this method, by means of the setting device, each strand is supplied with a phase current or with a phase voltage as the setting parameter and the setting parameter is regulated for each strand independently of the setting parameters for the other strands. By means of an additional active control element, the potential of the connection point is shifted as a function of the setting parameters.

In an analogous manner to that described above, a simple operation is made possible apparatus-wise with a simultaneously large dynamic response.

This method is particularly suitable when the electrical multiphase machine is configured as a bearingless motor in the sense described further above.

For the operation of the bearingless motor, preferably at least one common connection point is connected to precisely one strand of the drive winding and to precisely one strand of the control winding and the potential of the connection point is shifted to change the setting parameter in one of the two strands.

Further advantageous measures and aspects of the invention result from the dependent claims.

The invention will now be explained in more detail in both an apparatus and method aspect with reference to embodiments and to the drawing. There are shown in the schematic drawing:

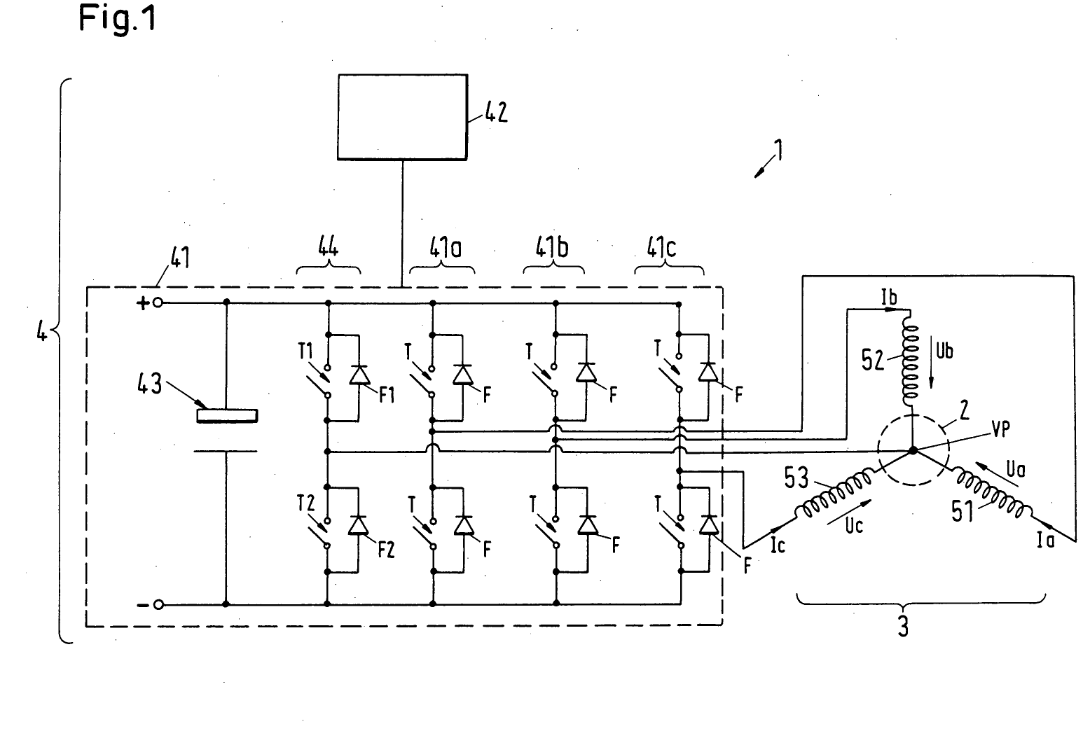

FIG. 1 a schematic illustration of a first embodiment of the multiphase machine in accordance with the invention:

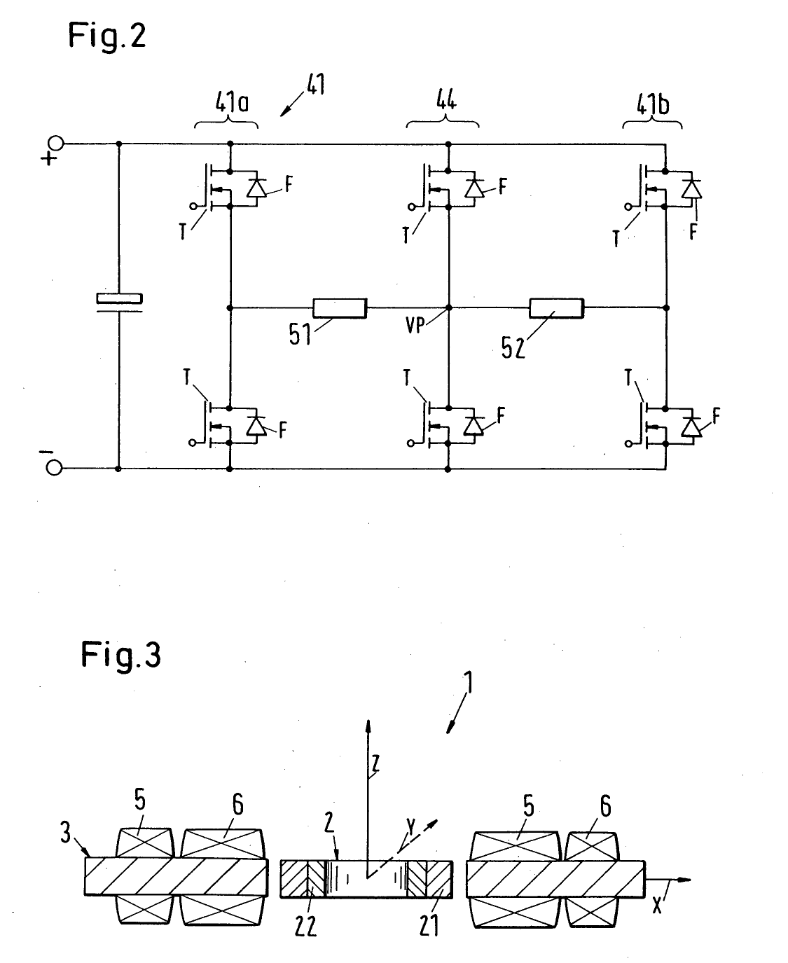

FIG. 2 an electrical circuit diagram of an amplifier unit for supplying the individual strands;

FIG. 3 a section through the stator of a second embodiment configured as a bearingless motor; and

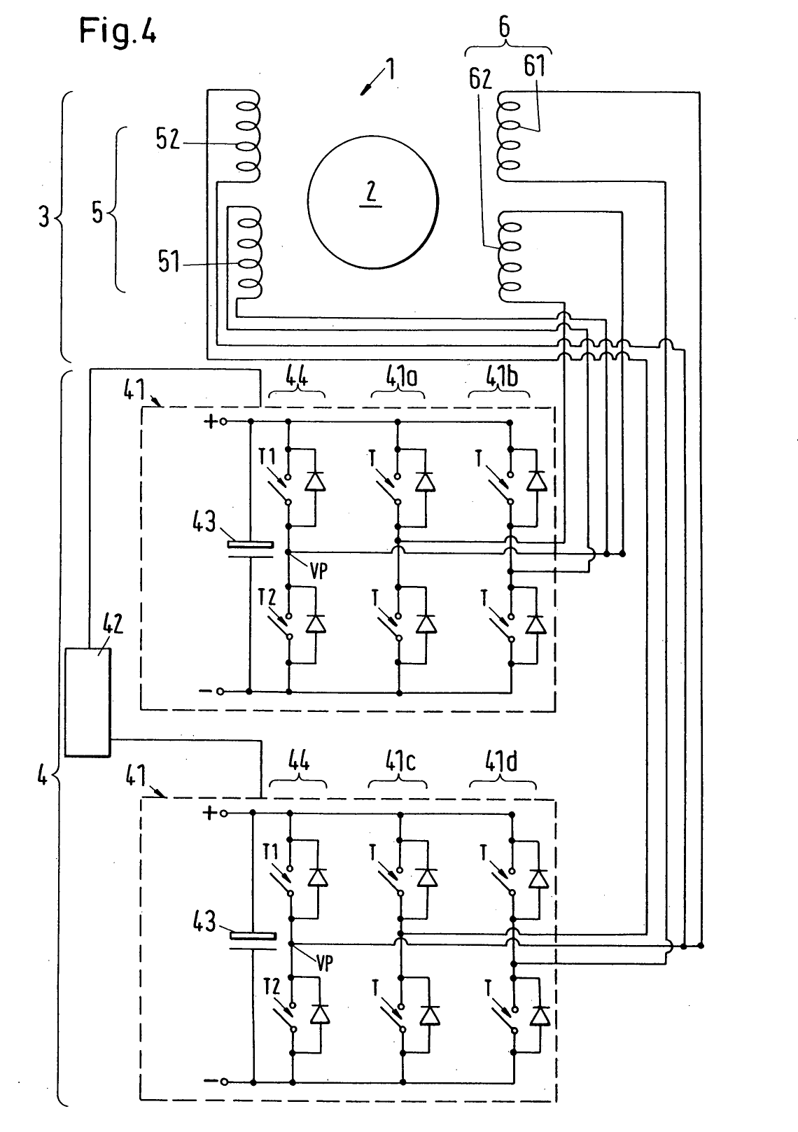

FIG. 4 a schematic illustration of a second embodiment of the multiphase machine in accordance with the invention.

In the following description of the embodiments with reference to the drawing, identical parts or parts which are the same with respect to function are provided with the same reference numerals.

The term “electrical multiphase machine” is intended to cover all electrical machines for the operation of which more than one electrical phase is required. These are in particular: electrical rotary drives, electromagnetic bearings, magnetic bearings, rotary drives with a separate magnetic bearing, bearingless motors, rotary field machines, pumps, pumps with a magnetically journalled rotor.

FIG. 1 shows in a schematic illustration, a first embodiment of an electrical multiphase machine in accordance with the invention. In this embodiment, the multiphase machine identified as a whole by reference numeral 1 is an electrical rotary drive. The rotary drive 1 includes a rotor 2, a stator 3 and a setting device 4 with an amplifier unit 41 and a regulator unit 42.

The stator 3 has a winding, namely a drive winding which in this embodiment has three strands 51, 52, 53, which each belong to a different electrical phase, i.e. the drive winding is configured as three-phase. By means of the drive winding, a magnetic rotary field can be generated as a drive field, which effects a torque at the rotor 2 whereby it is set in rotation.

It is understood that the rotary drive can also be made as two-phase in more or less the same manner, i.e. with a drive winding which has two strands or n-phased (where n>3), i.e. with a drive winding which has n strands.

The drive winding with the three strands 51, 52, 53 is wound in a manner known per se on the stator 3 and thus forms a plurality of discrete coils for generating the magnetic drive field. In this arrangement, a plurality of discrete coils can be electrically interconnected in a parallel circuit or in a series circuit. The totality of all of the discrete coils electrically interconnected in parallel or in series is termed a strand 51 or 52 or 53 of the drive winding. It is, of course, also possible that each strand 51, 52, 53 includes only one discrete coil.

Each strand forms a separate electric phase with the part of the setting device 4 supplying it. The setting device 4 can supply each strand 51, 52, 53 with a phase current Ia, Ib, Ic or phase voltage Ua, Ub, Uc respectively as the setting parameter. The setting device 4 may therefore be configured as a current setter or as a voltage setter for the drive winding. In the following, reference is made to the case that the setting device 4 is configured as a current setter.

The first embodiment is therefore a three-phase permanent magnet energized rotary field motor. The setting device 4 includes a separate power amplifier 41a, 41b or 41c for each strand 51, 52, 53 so that the setting parameter Ia, Ib, Ic, Ib, Ic or Ua, Ub, Uc for each strand 51, 52 or 53 can be regulated independently of the setting parameter for the other strands.

In the first embodiment the three power amplifiers 41a, 41b, 41c are each bridge branches of an amplifier unit 41 which is, for example, part of a multiphase current setter of which only the power part is shown in FIG. 1. The signal processing and regulating devices which may be integrated, for example, fully or partly in the amplifier unit 41 configured as an integrated circuit, are grouped together symbolically in the regulator unit 42 in FIG. 1.

A bridge branch of the amplifier unit 41 is provided for each strand 51, 52, 53 of the drive winding is as a separate bipolar power amplifier 41a, 41b or 41c. The term “bipolar” means that both the phase currents and the phase voltages can assume a positive or negative sign. Each bridge branch can supply the associated strand 51 or 52 or 53 with the phase current Ia, Ib, Ic or phase voltage Ua, Ub, Uc in each case by means of power switches T and freewheeling diodes F in a manner known per se. The power switches T are, for example, switching transistors configured as field-effect transistors (FETs), MOS-FETs or particularly insulated gate bipolar transistors (IGBTs). The amplifier unit 41 is operated with two operating potentials designated + and − in FIG. 1. The +, − operating potentials are DC potentials. They are be selected, for example, to be symmetrical to ground potential. Preferably, however, the ground potential is selected as the negative operating potential −. For feeding the amplifier unit 41, a stabilized voltage source is provided. This voltage source is usually a rectifier which makes available this operating voltage called an intercircuit voltage (difference of the operating potentials +, −). For stabilizing the operating voltage, a capacitor 43 is provided between the two operating potentials +,−.

Each strand 51, 52, 53 is connected, on one hand, to the bipolar power amplifier 41a, 41b, 41c supplying it. On the other hand, each strand is connected to a common connection point VP. In the present embodiment, the three strands 51, 52, 53 of the drive winding are therefore connected in a star-point circuit with the common connection point VP (that is the star point in this case) being loadable, i.e. being connected to a loadable potential. The potential of the connection point is usually selected and stabilized so that it is located exactly in the middle between the two operating potentials +,−.

In accordance with the invention, an active control element 44 is provided for shifting the potential of the connection point VP. The term active control element thus means a controllable device which actively sets and maintains the potential of the connection point at a predefined value, for example a voltage source which can be regulated.

The active control element 44, as in the present embodiment, is preferably configured as a bridge branch 44 of the amplifier unit 41, i.e. in the same way as the power amplifiers 41a, 41b, 41c. The control element 44 therefore includes—like the other bridge branches—two power switches T1 and T2, each provided with a freewheeling diode F1, F2 connected in parallel. On the one hand, the power switch T1 is connected to the positive operating potential + and, on the other hand, to the common connection point VP. The power switch T2 is connected, on the one hand, to the negative operating potential—and, on the other hand, to the common connection point VP. The control and regulation devices for the active control element 44 are likewise provided in the regulator unit 42.

The power amplifiers 41a, 41b or 41c and active control element 44 are operated by the method known per se of pulse width modulation (PWM). During the operation, desired values for the phase currents Ia, Ib, Ic are calculated from the sensor signals in the regulator unit 42. The regulator unit 42 then determines for each of the phase currents Ia, Ib, Ic the mark to space ratio for the two power switches T of the respective power amplifier 41a, 41b, 41c configured as a bridge branch and controls the corresponding power switches T by a signal so that this mark to space ratio is realized and the desired phase current is impressed as the setting parameter in the corresponding strand 51, 52, 53.

The active control element 44 is activated in more or less the same manner. If the two power switches T1 and T2 are activated with a fixed mark to space ratio of 50%, i.e. the power switch T1 is open and closed just as often or just as long in time as the power switch T2, then the potential of the connection point VP is exactly in the middle between the two operating potentials +, −, or in other words, the two operating potentials +, − are symmetrical as regards the potential of the connection point VP. This operating condition corresponds to the condition of a star-point circuit in which the star point is stabilized to a potential in the middle between the two operating potentials.

If a phase current is to be impressed in one of the strands 51, 52, 53 which exceeds the maximum current capable of being generated on average with half the operating voltage, the regulator unit 42 changes the mark to space ratio of the two power switches T1 and T2 of the active control element 44. The potential of the connection point VP is shifted thereby. If, for example, the power switch T2 is closed more often or kept closed longer than the power switch T1, the potential of the connection point VP is shifted in the direction of the negative operating potential −. If, however, the mark to space ratio is changed so that the power switch T1 is closed more often or is kept closed longer than the power switch T2 then the potential of the connection point VP is shifted in the direction of the positive operating potential. It is possible by this measure to lower the potential of the connection point VP at least approximately down to the negative operating potential—or to elevate it up to the positive operating potential +. By this shifting of the potential of the connection point, the resulting voltage applied to the strand 51 or 52 or 53 can be increased or reduced in a controlled manner depending on which phase current is needed in this strand 51 or 52 or 53. The regulator unit includes the control means for shifting the potential of the connection point VP in a controlled manner and to stabilize it at a predefined value.

The solution proposed in accordance with the invention has the advantage that it is less complex apparatus-wise and nevertheless ensures a high dynamic response. When configured with bridge branches, the number of power switches and flywheel diodes can be halved from four to two as compared to the known solution with an H-bridge circuit. In the embodiment of the solution in accordance with the invention, two additional power switches are admittedly needed for the active control element 44; however, the number of power switches T and freewheeling diodes F for an n-phase machine is reduced overall by 2(n−1). This represents a major advantage with respect to the reduction in costs and also to space requirement. At the same time, at least approximately the same dynamic response can be achieved as with the H-bridge circuits, since by shifting the potential of the connection point VP, at least approximately the full potential difference is available between the two operating potentials +, − with both signs for application to the strands of the phases. In known star point circuits this is not the case, for example, there only half of the difference of the operating potentials is available, meaning a significantly lower dynamic response.

FIG. 2 shows an electrical circuit diagram of an amplifier unit 41 for supplying two strands 51, 52 of an electrical multiphase machine. The reference numerals are to be understood as already explained in conjunction with FIG. 1.

The amplifier unit 41 includes three bridge branches, two of which serve as power amplifiers 41a, 41b for the two strands 51, 52 and one as the active control element 44 with which the potential of the common connection point VP can be shifted in a controlled manner to any desired values between the two operating potentials +, −.

An amplifier unit 41 of the type shown in FIG. 2 can be realized in particular with a three-phase rotary current setter.

Depending on the type of electrical multiphase machine, it is possible that greatly differing currents have to be impressed in the strands of the various phases. In an electrical rotary drive additionally having magnetic bearings, at least two windings are usually provided, namely a drive winding and a control or bearing winding, each of which may be configured in multiphase.

Typically, the strands of the drive winding have a substantially higher current requirement than the strands of the bearing winding. It is then of advantage with the amplifier unit 41 in accordance with FIG. 2 to interconnect one strand of the bearing winding and one strand of the drive winding via the common connection point VP, since the current flowing through the common connection point VP can be kept as small as possible by this measure.

If the electrical multiphase machine is configured, for example, as a rotary drive with a magnetically journalled rotor and has a two-phase drive winding and a four-phase control or bearing winding, it is possible to use three amplifier assemblies 41 each configured in accordance with FIG. 2. Then preferably with two amplifier units 41, one strand of the drive winding and one strand of the bearing winding each are connected to the common connection point VP, whilst in the third amplifier unit the two remaining strands of the bearing winding are connected to the common connection point VP. That is, two of the amplifier units 41 supply precisely one strand of the drive winding and precisely one strand of the bearing winding each, whilst the third amplifier unit 41 supplies two strands of the bearing winding. Three three-phase setters can be used in this connection and the current flowing through the common connection point VP in each case can be minimized.

Alternatively, it is also possible to connect all six strands of such a multiphase machine—i.e. the two strands of the drive winding and the four strands of the bearing winding—to the same connection point VP in the same manner more as less as in FIG. 1. In such a configuration, a multiphase current or voltage setter is used as the amplifier unit 41 and includes seven bridge branches, six of which are used as power amplifiers for the six strands and one for stabilizing and shifting the potential of the common connection point VP.

A second embodiment of an electrical multiphase machine in accordance with the invention is shown in FIGS. 3 and 4 configured as a so-called bearingless motor 1. FIG. 3 shows a section through the stator 3 and FIG. 4 shows as schematic illustration of the second embodiment of the multiphase machine in accordance with the invention.

A bearingless motor 1 is disclosed for example in WO-A-96/31934. The bearingless motor owes its name to the fact that in this electromagnetic rotary drive the rotor 2 is journalled without contact with respect to the stator 3 by means of magnetic forces, with no separate magnetic bearings being present for the rotor 2. For this purpose, the stator 3 is designed as a bearing and drive stator including two windings, namely a drive winding 5 for generating a magnetic drive field which effects a torque on the rotor 2, and a control winding 6 for generating a magnetic control field with which the position of the rotor relative to the stator 3 can be regulated. With these two windings 5, 6 a magnetic rotary field can therefore be produced which, on the one hand, effects a torque on the rotor 2 causing it to rotate, and which, on the other hand, exerts an optionally adjustable transverse force on the rotor 2, so that its radial position can be actively controlled or regulated respectively. Thus, three degrees of freedom of the rotor can be actively regulated. With respect to three further degrees of freedom, namely its axial deflection in the direction of the axis of rotation and tilts with respect to the plane which is perpendicular to the axis of rotation (two degrees of freedom) the rotor is stabilized passively magnetically, that is non-controllably, by reluctance forces. The axis of rotation about which the rotor 2 rotates in the operating condition when it is in an exactly centered position as regards the stator 3, defines the Z axis of a system of coordinates X, Y, Z which is fixed as regards the stator 3. The direction of the Z axis is termed the axial direction, the radial position of the rotor is its position in the plane perpendicular to the axis of rotation dictated by the two other coordinate axes X, Y. The system of coordinates has its origin in the center of the stator 3.

In the second embodiment, the drive winding has two strands 51, 52 and the control winding 6 has two strands 61,62 i.e. both windings are configured as two-phase, providing two drive phases and two control phases.

With the bearingless motor, the drive winding 5 and the control winding 6 are preferably configured so that their number of pole pairs differs by one, i.e. when the drive winding has p pole pairs, the control winding has p±1 pole pairs. In the embodiment described here, the drive winding 5 has the pole pair number 1, that is it is two-pole, and the control winding 6 has the pole pair number two, that is it is four-pole.

The rotor 2 is configured as a permanent magnet, disk or ring-shaped rotor 2, here, for example, with a permanent magnet ring 21 and an iron yoke 22 arranged radially internally as regards the ring 21.

For the control and supply of the individual strands 51, 52, 61, 62, the setting device 4 includes two amplifier units 41. Each amplifier unit 41 is configured substantially the as shown in FIG. 2. Specifically, each amplifier unit 41 includes a three-phase current setter with three bridge branches. Two each of the bridge branches in each case serve as separate power amplifiers 41a, 41b, 41c, 41d for the four strands 51, 52, 61, 62 of the drive winding 5 and control winding 6; the respective third bridge branch serves as the active control element 44 for shifting the potential of the connection point VP in each case.

The device for signal processing, control and regulation for the amplifier units 41 are grouped together symbolically in the regulator unit 42.

Since the drive phases usually have a significantly higher current requirement than the control phases, one strand 51, 52 each of the drive winding 5 is connected to a strand 61, 62 of the control winding 6 in each of the two amplifier assemblies 41 via the common connection point VP, that is each connection point VP is connected to precisely one strand 51, 52 of the drive winding 5 and to precisely one strand 61, 62 of the control winding 6. The amplifier unit 41 shown at the top in FIG. 4 supplies the strand 61 of the control winding 6 and the strand 51 of the drive winding 5 by the power amplifiers 41a and 41b. The amplifier unit 41 shown at the bottom in FIG. 4 supplies the strand 52 of the drive winding 5 and the strand 62 of the control winding 6 by the power amplifiers 41c and 41d. It is by this combination of one drive phase and one control or bearing phase in each case that the current flowing through the connection point in each case can be kept as low as possible.

Other combinations of the various phase are naturally also possible. For example, one of the two amplifier units 41 may supply the two strands of the drive winding 5 and the other amplifier unit 41 the two strands of the control winding 6. It is furthermore possible, in a departure from the representation of FIG. 4, to connect all strands 51, 52, 61, 62 to a common connection point VP in an analogous manner as was described in conjuntion with FIG. 1.

It is understood that also another number of phases may be provided for the drive winding and/or control winding. Also, such configurations are possible in which the number of strands connected to the same connection point differs for differing connection points, i.e., for example, one connection point is connected to two strands whilst another is connected to four strands.

If during operation a mark to space ratio of 50% is selected in each case for the power switches T1, T2 of the two active control elements 44 in the amplifier units 41, a potential results at each of the two connection points VP which is precisely in the middle between the two operating potentials +,−. The voltage highest in amount that can be applied to one of the strands 51, 52, 61, 62 is then half the operating voltage, i.e. half the difference between the two operating potentials +,−. The regulation of the phase current (or of the phase voltage) takes place via the mark to space ratio of the two power switches T of the bridge branch supplying the strand belonging to this phase.

If, for example, more current should be impressed in the strand 51 of the drive winding 5 than is possible by half the operating voltage in time average, the mark to space ratio of the power switches T1 and T2 of the associated active control element 44 is altered so that the potential of the connection point VP is shifted from its symmetrical position. Consequently, the resulting voltage applied to the strand 51 of the drive winding 5 being increased or decreased, depending on which torque and which phase current derived therefrom is required by the rotary drive 1.

The voltage required for the magnetic bearing at the strands 61, 62 of the control winding 6 is ensured more or less in the same manner by more setting voltage being made available to the strands 61, 62 of the control winding 6 at the cost of the setting parameter for the drive winding.

Thus, by means of the additional active control elements 44, the potential of the connection points VP is shifted as a function of the setting parameters required.

The electrical multiphase machine in accordance with the invention may also be configured in particular as an electromagnetic rotary drive with a magnetically journalled rotor wherein at least one separate magnetic bearing is provided for the rotor, i.e. wherein at least one stator is provided for the drive and at least one stator, different thereto, is provided for the magnetic bearing of the rotor.

Furthermore, the multiphase machine in accordance with the invention may also be configured in particular as a magnetic bearing. A configuration is also possible in which a bearingless motor is combined with separate magnetic bearing devices.

A further preferred embodiment of the multiphase machine in accordance with the invention is that of a pump, specifically a rotational pump. The pump can in particular be configured according to the principle of the bearingless motor. The rotor can then be configured as an integral rotor, that is the rotor functions both as the rotor of the motorized rotary drive and as the rotor of the pump. Reference is made to the already cited documents with respect to further details of such a rotational pump.

1. An electrical multiphase machine with a stator (3) which includes a winding (5;6) having at least two strands (51, 52, 53; 61, 62) for generating an electromagnetic field, each strand (51, 52, 53; 61, 62) belonging to a different electrical phase; furthermore with a setting device (4) which supplies each strand (51, 52, 53; 61, 62) with a phase current (Ia, Ib, Ic) or phase voltage (Ua, Ub, Uc) in each case as a setting parameter, said setting device (4) including a separate power amplifier (41a, 41b, 41c, 41d) for each strand (51, 52, 53; 61, 62), so that the setting parameter can be regulated for each strand (51, 52, 53; 61, 62) independently of the setting parameters for the other strands (51, 52, 53; 61, 62) and at least one common connection point (VP) being provided to which at least two of said strands (51, 52, 53; 61, 62) are connected, characterized in that an additional active control element (44) is provided for shifting the potential of said connection point (VP).

2. A multiphase machine in accordance with claim 1 configured as a bearingless motor with a magnetically journalled rotor (2), said stator (3) including two windings, namely a drive winding (5) having at least two strands (51, 52) for generating a magnetic drive field which effects a torque on said rotor (2), and a control winding (6) having at least two strands (61, 62) for generating a magnetic control field with which the position of said rotor (2) can be regulated relative to said stator (3), each strand (51, 52) of said drive winding (5) belonging to a different electrical drive phase and each strand (61, 62) of said control winding (6) belonging to a different electrical control phase, said setting device (4) for each strand (51, 52) of said drive winding (5) and for each strand (61, 62) of said control winding (6) including a separate power amplifier (41a, 41b, 41c, 41d), so that the setting parameter for each strand (51, 52, 61, 62) can be regulated independently of the setting parameters for the other strands

3. A multiphase machine in accordance with claim 2, wherein each power amplifier (41a, 41b, 41c, 41d) and each active control element (44) is configured in each case as a bridge branch of said setting device (4).

4. A multiphase machine in accordance with claim 3, wherein all strands (51, 52, 53; 61, 62) are connected to the same connection point (VP).

5. A multiphase machine in accordance with claim 4, with a plurality of different connection points (VP), wherein, for each connection point (VP), an additional active control element (44) is provided for shifting the potential of each connection point (VP).

6. A multiphase machine in accordance claim 1, wherein said setting device (4) includes at least one three-phase current or voltage setter with three bridge branches, two of said bridge branches being said power amplifiers (41a, 41b, 41c, 41d) for two strands and said third bridge branch being said active control element (44).

7. A multiphase machine in accordance with claim 6, wherein at least one connection point (VP), preferably each connection point (VP), is connected to precisely one strand (51, 52) of said drive winding (5) and to precisely one strand (61, 62) of said control winding (6).

8. A method for operating an electrical multiphase machine with a stator (3) which includes a winding (5; 6) having at least two strands (51, 52, 53; 61, 62) for generating an electromagnetic field, each strand (51, 52, 53; 61, 62) belonging to a different electrical phase; furthermore with a setting device (4) including a separate power amplifier (41a, 41b, 41c, 41d) for each strand (51, 52, 53; 61, 62), and at least one common connection point (VP) being provided to which at least two of said strands are connected, in which method, by means of said setting device (4,) each strand (51, 52, 53; 61, 62) is supplied with a phase current (Ia, Ib, Ic) or with a phase voltage (Ua, Ub, Uc) as said setting parameter in each case and said setting parameter is regulated for each strand (51, 52, 53: 61, 62) independently of the setting parameters for the other strands, characterized in that, by means of an additionally active control element (44), the potential of said connection point (VP) is shifted as a function of the setting parameters.

9. A method in accordance with claim 8, wherein said electrical multiphase machine is configured as a bearingless motor.

10. A method in accordance with claim 9, wherein at least one common connection point (VP) is connected to precisely one strand (51, 52, 53) of said drive winding (5) and to precisely one strand (61, 62) of said control winding (6) and wherein the potential of said connection point (VP) is shifted to change said setting parameter in one of said two strands.
